(19) United States
(12) Patent Application Publication
(10) Pub. No.: US 2026/0135806 A1
(43) Pub. Date: May 14, 2026

(54) UNIQUE ELEMENT ESTIMATION IN HARDWARE

(71) Applicant: Arista Networks, Inc., Santa Clara, CA (US)

(72) Inventor: Francois LABONTÉ, Menlo Park, CA (US)

(21) Appl. No.: 18/944,739

(22) Filed: Nov. 12, 2024

(51) Int. Cl. H04L 45/745; H04L 45/7453; H04L 47/2441

(52) U.S. Cl. CPC H04L 45/74591; H04L 45/7453; H04L 47/2441

(57) ABSTRACT

A hardware-based framework is provided that enables a network device to accurately estimate the cardinality of (or in other words, the number of unique elements in) a stream of network packets processed by the device, using minimal memory and compute resources. For example, this framework can enable the network device to accurately estimate the number of unique network flows in the packet stream, the number of unique source Internet Protocol (IP) addresses in the packet stream, the number of unique flows for each of a plurality of packet classification characteristics (e.g., ingress ports on which the packets were received, egress ports on which the packets are sent out, etc.), and so on.

### BACKGROUND

Modern network devices process network traffic at very high rates, in some cases in the range of billions of packets per second. Given these high rates, it can be challenging for a network device to determine the number of unique elements in a packet stream processed by the device without consuming large amounts of memory and/or compute resources.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example network device in accordance with certain embodiments of the present disclosure.

FIG. 2 depicts another example network device in accordance with certain embodiments of the present disclosure.

FIG. 3 depicts a hashing and bucket assignment workflow in accordance with certain embodiments of the present disclosure.

FIG. 4 depicts a cardinality estimation workflow in accordance with certain embodiments of the present disclosure.

FIG. 5 depicts another hashing and bucket assignment workflow in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to a hardware-based framework that enables a network device to accurately estimate the cardinality of (or in other words, the number of unique elements in) a stream of network packets processed by the device, using minimal memory and compute resources. For example, this framework can enable the network device to accurately estimate the number of unique network flows in the packet stream, the number of unique source Internet Protocol (IP) addresses in the packet stream, the number of unique flows for each of a plurality of packet classification characteristics (e.g., ingress ports on which the packets were received, egress ports on which the packets are sent out, etc.), and so on.

### 1. Example Network Device

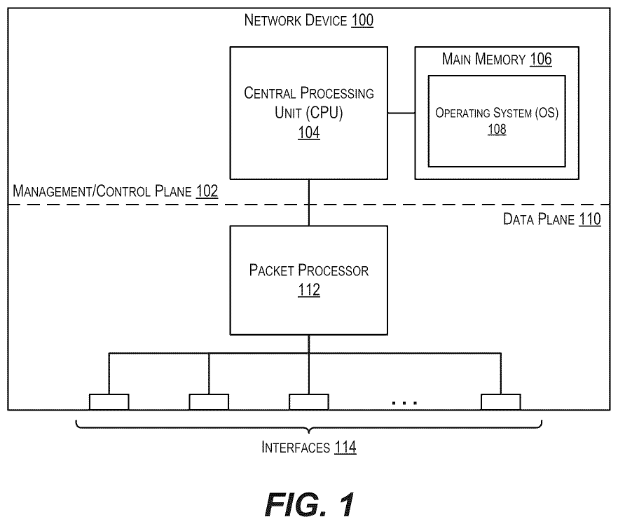

FIG. 1 is a simplified block diagram of a network device 100 in which the framework of the present disclosure may be implemented. As shown, network device 100 comprises a management/control plane 102 that includes a central processing unit (CPU) 104 and a main memory (e.g., random-access memory or RAM) 106. CPU 104 is a general-purpose processor that is responsible for managing the configuration/operation of network device 100 and controlling the device's understanding of the network in which it resides. CPU 104 carries out these functions under the direction of an operating system (OS) 108 that runs on CPU 104 from main memory 106.

Network device 100 also comprises a data plane 110 including a packet processor 112 and a set of front-panel interfaces (i.e., ports) 114. Packet processor 112 is typically an integrated circuit, such as an application-specific integrated circuit (ASIC) or a field-programmable gate array (FPGA), that is responsible for processing, at line speed, streams of network packets (i.e., traffic) that pass through network device 100 via front-panel interfaces 114. This packet processing can include, for example, Layer 2 (L2) forwarding and Layer 3 (L3) routing of network traffic.

For reasons such as network monitoring, troubleshooting, and traffic analysis, it is useful for network device 100 to be capable of counting/estimating the number of unique elements (e.g., unique network flows, unique source IP addresses, unique destination IP addresses, etc.) that are encountered in the packet streams processed by packet processor 112. There are several existing algorithms for determining an exact count of the number of unique elements in, or in other words the cardinality of, a dataset. However, these existing algorithms generally require an amount of memory that is proportional to the number of unique elements, which makes the algorithms impractical for counting the cardinality of packet streams on network devices because modern network devices typically process millions or billions of packets per second while having relatively limited memory resources.

There is also an existing algorithm called HyperLogLog (HLL) that is designed to accurately estimate the number of unique elements in a dataset with low memory usage. The execution of HLL generally comprises two phases: a hashing and bucket assignment phase and an estimation phase. During the hashing and bucket assignment phase, each element in the dataset is hashed using a “good” hash function that uniformly distributes inputs across a large output/hash space. The resulting hash value (in binary form) is split into two portions: a bucket address and a remainder. The bucket address is used to identify a bucket (from a fixed-size array of buckets) to which the element belongs. The remainder can be understood as a binary representation of the element and is examined to determine how “rare” the element is. Upon making this determination, the identified bucket is updated to reflect the rarest element seen so far in the bucket. “Rarity” in this context is defined by how many bits in a chosen binary sequence are seen. For example, in one set of embodiments the rarity of the element can be defined by the number of leading zeros in its remainder, such that the rarest element has a remainder with the most leading zeros. Finally, during the estimation phase, all of the bucket values are read and used to compute an overall estimate of the number of unique elements in the dataset.

Because the size of the bucket array used by HLL is independent of (and generally much smaller than) the number of unique elements being counted, HLL consumes significantly less memory resources than the existing cardinality counting algorithms mentioned above. Further, when configured with a good hash function and an appropriate number of buckets, HLL can produce an estimate that is typically within one or two percentage points of the exact cardinality count. However, conventional HLL is implemented entirely in software, which makes it impractical for use as-is on network devices like device 100 of FIG. 1 for estimating the number of unique elements in a packet stream due to the very high packet processing rates noted previously. In particular, the hashing and bucket assignment phase (which requires operations to be performed on a per-packet basis) can consume a significant amount of compute power, to the point of overwhelming the network device's CPU.

### 2. Solution Overview

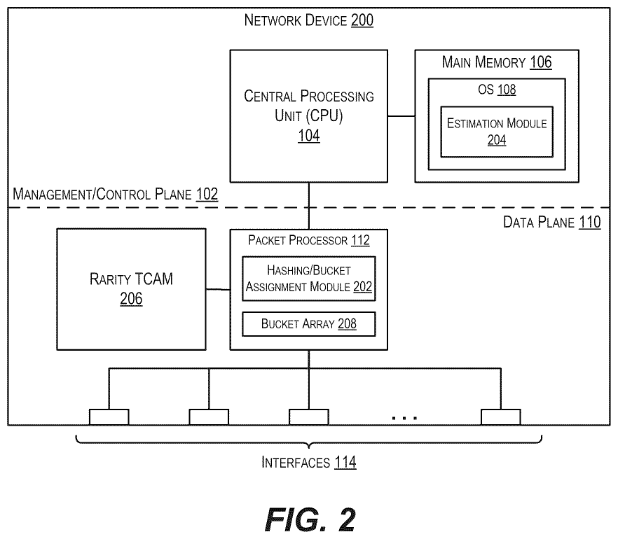

To address the foregoing, FIG. 2 depicts a modified version 200 of network device 100 that employs a hardware-based cardinality estimation (HCE) framework comprising a hashing/bucket assignment module 202 in packet processor 112 and an estimation module 204 in OS 108. Hashing/bucket assignment module 202 can be implemented in the hardware of packet processor 112, such as via one or more hardware counter engines of the packet processor. Estimation module 204 can be implemented as software (i.e., program code) that is executable by a processor of network device 200, such as CPU 104.

The HCE framework also includes a rarity TCAM 206 in data plane 110 that is communicatively coupled with, or alternatively integrated into, packet processor 112 and a bucket array (i.e., table) 208 that is maintained in a memory of packet processor 112. As known in the art, a TCAM (ternary content-addressable memory) is a type of physical memory that enables fast, parallel lookups of its data contents against an input. More specifically, a TCAM stores a plurality of entries, where each TCAM entry includes a data field (comprising a bitstring against which a binary input is compared/matched) and a result field. The data field of a TCAM entry can be modified by a bitmask that specifies which bits in the data field should be considered during the lookup process. Multiple TCAM entries can match a lookup and in this case the entries are ordered by priority such that the highest priority entry that matches will return a result.

As described in further detail below, the HCE framework enables network device 200 to accurately estimate the number of unique elements found in a packet stream processed by packet processor 112 using minimal amounts of memory and compute resources. At a high level, the HCE framework achieves this by executing the hashing and bucket assignment phase of the HLL algorithm in hardware (using hashing/bucket assignment module 202, rarity TCAM 206, and bucket array 208) and executing the estimation phase of the HLL algorithm in software (using estimation module 204). Such an approach allows the framework to retain the memory-saving advantages of conventional HLL while also eliminating the CPU overhead of the hashing and bucket assignment phase (which is now handled entirely in hardware).

In certain embodiments, the HCE framework can be configured to produce a cardinality estimate for each of one or more different types of elements in a packet stream. Examples of such element types include network flows, source IP addresses, destination IP addresses, as well as any other type of element found in, or derivable from, the header of a network packet. In further embodiments, the HCE framework can be configured to produce cardinality estimates for an element type across different packet classification characteristics, such as the number of unique flows received on each ingress port of network device 200, the number of unique flows sent out on each egress port of network device 200, the number of unique flows that match a given counting policy, and so on. These various options for configuring the HCE framework can be exposed to device users and other entities via one or more interfaces (e.g., the device's command line interface (CLI), programmatic interfaces invoked by automated agents, etc.).

It should be appreciated that FIGS. 1 and 2 and the foregoing high-level description are illustrative and not intended to limit embodiments of the present disclosure. For example, although FIG. 2 depicts a particular arrangement of framework components in network device 200, other arrangements are possible (e.g., the functionality attributed to a particular component may be split into multiple components, components may be combined, etc.). One of ordinary skill in the art will recognize other similar modifications, variations, and alternatives.

### 3. Hashing and Bucket Assignment

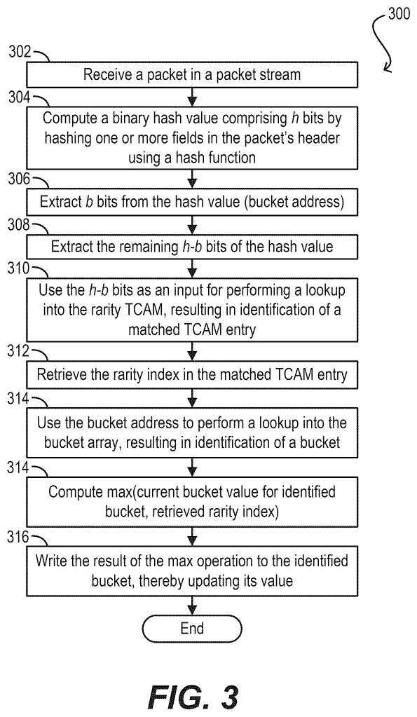

FIG. 3 depicts a workflow 300 that can be executed by hashing/bucket assignment module 202 of network device 200 for processing a packet in a packet stream for producing a cardinality estimate for that stream.

Starting with steps 302 and 304, hashing/bucket assignment module 202 can receive the packet and can compute a binary hash value comprising h bits by hashing, using a hash function, one or more fields in the packet's header. These one or more packet header fields identify the element in the packet for which cardinality estimation is being performed. For example, if the HCE framework has been configured to estimate the number of unique network flows in the packet stream, module 202 will compute the hash value by hashing all packet header fields that collectively identify the flow to which the packet belongs, such as the packet's 5-tuple (i.e., source IP address, source port, destination IP address, destination port, protocol) for a standard UDP over IP or TCP over IP packet. As another example, if the HCE framework has been configured to estimate the number of unique source IP addresses, module 202 will compute the hash value by only hashing the packet's source IP address.

At step 306, hashing/bucket assignment module 202 can extract b bits from the hash value, referred to as the bucket address for the packet, where b is some number less than h and greater than zero. For example, in one set of embodiments module 202 can extract the least significant b bits of the hash value as the bucket address. In another set of embodiments, module 202 can extract the most significant b bits of the hash value as the bucket address.

Hashing/bucket assignment module 202 can then extract the remaining h-b bits of the hash value (step 308) and use these h−b bits as an input for performing a lookup into rarity TCAM 206, resulting in the identification of a matched TCAM entry (step 310). In certain embodiments, it is assumed that rarity TCAM 206 is populated with a total of h−b+1 entries in order from highest priority to lowest priority, where the data field of each TCAM entry has a value (bitstring) that is h-b bits long and where the result field of each TCAM entry has a rarity index indicating the rarity of the data field bitstring. For example, if h=20 and b=14, rarity TCAM 206 will be populated with 20−14+1=7 TCAM entries where the data field of each entry has a 20−14=6 bit-long bitstring. In certain embodiments, a higher rarity index indicates that the corresponding data field bitstring is more rare and a lower rarity index indicates that the corresponding data field bitstring is less rare.

In addition, it is assumed that the first (i.e., highest priority) TCAM entry in rarity TCAM 206 has a data field bitstring of all zeros (or all ones or any other arbitrarily chosen bit sequence) and a rarity index of h−b+1, the second (i.e., second highest priority) TCAM entry has a data field bitstring of all zeros (or all ones or any other arbitrarily chosen bit sequence) with the least significant bit masked and a rarity index of h−b, the third (i.e., third highest priority) TCAM entry has a data field bitstring of all zeros (or all ones or any other arbitrarily chosen bit sequence) with the two least significant bits masked and a rarity index of h−b−1, the fourth (i.e., fourth highest priority) TCAM entry has a data field bitstring of all zeros (or all ones or any other arbitrarily chosen bit sequence) with the three least significant bits masked and a rarity index of h−b−2, and so on, until the last (i.e., lowest priority) TCAM entry has a data field bitstring with all bits masked and a rarity index of one. For instance, in the example above where h=20 and b=14, rarity TCAM 206 can include the entries shown in Table 1 below. Note that in the data field column, “X” indicates a masked bit (which means that bit can be considered either a 0 or a 1 for matching purposes).

TABLE 1

| Data field | Result field |
|---|---|
| (bitstring to be matched) | (rarity index) |
| 000000 (or 111111) | 7 |
| 00000X (or 11111X) | 6 |
| 0000XX (or 1111XX) | 5 |
| 000XXX (or 111XXX) | 4 |
| 00XXXX (or 11XXXX) | 3 |
| 0XXXXX (or 1XXXXX) | 2 |
| XXXXXX | 1 |

As can be seen, only log 2(h−b+1) bits are needed to encode the rarity index because this index ranges from h−b+1 to zero.

Upon matching the h−b bits of the hash value to an entry in rarity TCAM 206, hashing/bucket assignment module 202 can retrieve the rarity index in the matched TCAM entry (step 312) and use the packet's bucket address to perform a lookup into bucket array 208, resulting in the identification of a bucket (i.e., array entry) to which the element in the packet belongs (step 314). Each bucket in bucket array 208 holds a bucket value indicating the rarest, or in other words most uncommon, element seen so far for that bucket.

Finally, hashing/bucket assignment module 202 can compute the max of the current bucket value for the identified bucket and the retrieved rarity index (which selects the larger of the two) (step 316) and can write the result of the max operation to the identified bucket, thereby updating its value (step 318). Workflow 300 can thereafter end and be repeated for additional packets received by module 202.

### 4. Cardinality Estimation

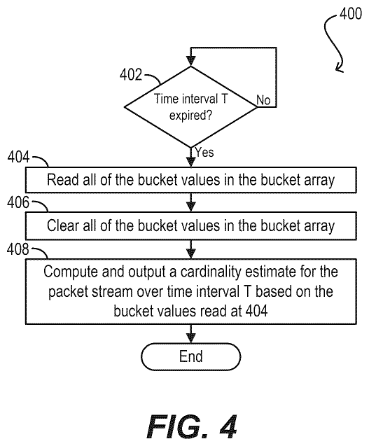

FIG. 4 depicts a workflow 400 that can be executed by estimation module 204 of network device 200 for producing a cardinality estimate for a packet stream according to certain embodiments. Workflow 400 is performed in parallel with workflow 300 of FIG. 3 and assumes that hashing/bucket assignment module 202 is continuously updating bucket array 208 in accordance with workflow 300 as packets in the packet stream are received.

Starting with step 402, estimation module 204 can check whether a time interval T configured for the cardinality estimation of the packet stream has expired. Time interval T represents the period for which the cardinality estimate applies. For example, if T is one minute, the resulting cardinality estimate will be an estimate of the number of unique elements found in the packet stream over the last minute.

If the answer is no, estimation module 204 can wait and return to step 402. However, if the answer is yes, estimation module 204 can read all of the bucket values in bucket array 208 (step 404) and clear those values from the array (step 406). Estimation module 204 can then compute and output a cardinality estimate for the packet stream over T based on the bucket values read at step 404 in accordance with the HLL algorithm (step 408). Workflow 400 can thereafter end and be repeated for the next time interval T.

In some cases, the HCE framework may be configured to produce cardinality estimates for a packet stream over multiple overlapping time scales, such as each second, each minute, each hour, etc. To handle this, estimation module 204 can keep track of the last-read value for each bucket for a given time scale and uses these tracked bucket values to compute the estimate for the next larger time scale. For example, in the scenario where the HCE framework is configured to produce a cardinality estimate for each second and each minute, estimation module 204 can record the value of each bucket at the end of each second; then, at the end of the 60th second, module 204 can compute the cardinality estimate for the past minute using the tracked bucket values for the last 60 seconds and delete those values (so that new bucket values can be tracked for the next 60 seconds).

### 5. Hashing and Bucket Assignment for Multiple Packet Classification Characteristics

As mentioned previously, in certain embodiments the HCE framework can produce cardinality estimates for a packet stream across multiple different packet classification characteristics such as the number of unique flows per ingress port, per egress port, per Equal-Cost Multi-Path (ECMP) group member, and so on. As part of this functionality, the HCE framework can allow device users to create a counting policy on network device 200 where the counting policy defines one or more packet classification characteristics for which cardinality estimation is desired. The framework can then produce an estimate for all packets in the packet stream that match that counting policy.

For example, the following is a sample counting policy that causes the HCE framework to produce unique flow estimates A through D for various combinations of source IP address (which is the first IP address shown in each entry below) and destination IP address (which is the second IP address shown in each entry below).

Listing 1
Policy flow estimate

| | | |
|---|---|---|
| 1.1.1.1 | 2.2.2.2 | flow-estimate A |
| 1.1.1.2 | 2.2.2.3 | flow-estimate B |
| 2.2.* * | * | flow-estimate C |
| * | 1.1.1.1 | flow-estimate D |

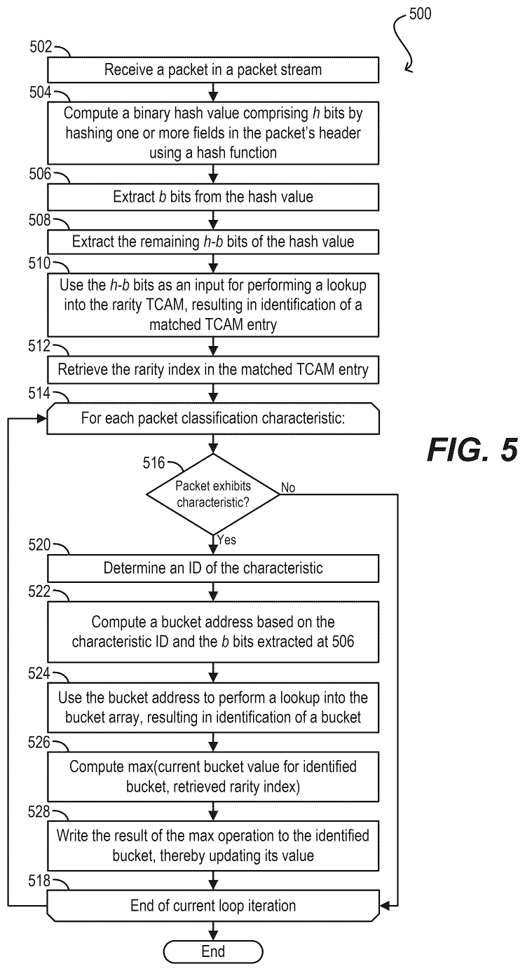

FIG. 5 depicts a workflow 500 that can be executed by hashing/bucket assignment module 202 of network device 200 for processing a packet in a packet stream for producing cardinality estimates for that stream across multiple packet classification characteristics according to certain embodiments.

Steps 502-512 are identical to steps 302-312 of workflow 300. At step 514, hashing/bucket assignment module 202 can enter a loop for each packet classification characteristic (or associated group of characteristics) for which a cardinality estimate is desired. This can be a particular ingress port, a particular egress port, a particular ECMP group member, a particular counting policy, or the like. Within the loop, hashing/bucket assignment module 202 can check whether the current packet exhibits the characteristic (or in other words, whether the characteristic applies to the packet) (step 516). For example, if the characteristic is a particular ingress port, this can involve checking whether the packet was received on that ingress port. Alternatively, if the characteristic is a particular ECMP group member, this can involve checking whether the packet will be sent to that ECMP group member. Alternatively, if the characteristic is a particular counting policy, this can involve checking whether the packet conforms to any of the entries/rules defined in the policy.

If the answer at step 516 is no, hashing/bucket assignment module 202 can proceed to the end of the loop (step 518). However, if the answer at step 516 is yes, hashing/bucket assignment module 202 can determine an identifier associated with the packet classification characteristic (e.g., ingress port number, egress port number, policy ID, etc.) (step 520) and compute a bucket address based on the characteristic ID and the b bits extracted from the hash value at step 506 (step 522). For example, in one set of embodiments, hashing/bucket assignment module 202 can concatenate these two values together to compute the bucket address. In cases where the characteristic IDs across the packet classification characteristics are non-contiguous (e.g., ingress port numbers 1, 3, and 10), the HCE framework can remap the characteristic IDs so that they resolve to contiguous bucket addresses in bucket array 208.

Hashing/bucket assignment module 202 can then use the bucket address to perform a lookup into bucket array 208, resulting in the identification of a bucket for the packet's element and the current packet classification characteristic (step 524), compute the max of the current bucket value for the identified bucket and the extracted rarity index (step 526), and write the result of the max operation to the identified bucket, thereby updating its value (step 528). Hashing/bucket assignment module 202 can thereafter reach the end of the current loop iteration and return to the top of the loop to process the next characteristics. Finally, upon completing this loop, workflow 500 can end and be repeated for additional packets received by module 202.

### 6. Cardinality Estimation for Multiple Packet Classification Characteristics

The process of producing cardinality estimates for a packet stream across different packet classification characteristics is largely similar to workflow 400 shown in FIG. 4 and described in section (4) above. This main difference is that multiple instances of workflow 400 will be carried out concurrently, where each instance is directed to the computation of an estimate for a particular characteristic (e.g., a particular ingress port, a particular egress port, etc.). Further, in the context of each instance, estimation module 204 will only read the bucket values for the buckets in bucket array 208 that are associated with that instance's characteristic.

### 7. Handling Distributed Ingress and Egress Packet Processors

In some scenarios, network device 200 may employ distinct ingress and egress packet processors (or processing pipelines), which means that ingress packet processing (i.e., the handling of incoming packets) is handled by one processor and egress packet processing (i.e., the handling of outgoing packets) is handled by another, separate processor. In these scenarios, if cardinality estimation is enabled on both a per-ingress port and per-egress port basis, the hashing and rarity TCAM lookup for a packet that passes through the device will need to be performed twice-once on the ingress side and again on the egress side.

To avoid this inefficiency, in certain embodiments the ingress packet processor can add the bucket address and rarity index that it determines for the packet to an internal packet header. Then, when the packet is received on the egress side, the egress packet processor can simply extract this information from the internal packet header in order to update its bucket array, rather than having to recompute the bucket address from the packet's hash value and re-execute the rarity TCAM lookup.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device for producing a cardinality estimate for a stream of packets processed by the network device, the method comprising:
receiving, by a packet processor of the network device, a packet that is part of the stream of packets;
hashing, by the packet processor, a portion of the packet using a hash function, the hashing resulting in a hash value;
determining, by the packet processor, an address of a bucket in a bucket array based on a first set of bits of the hash value;
performing, by the packet processor, a lookup into a ternary content-addressable memory (TCAM) using a second set of bits of the hash value, the lookup resulting in identification of a matched TCAM entry;
computing, by the packet processor, a maximum of a current value in the bucket and an index taken from the matched TCAM entry; and
writing, by the packet processor, the computed maximum into the bucket.

2. The method of claim 1 wherein the portion of the packet that is hashed includes one or more packet header fields that identify a network flow to which the packet belongs, and wherein the cardinality estimate is an estimated count of unique network flows in the stream of packets.

3. The method of claim 1 wherein the portion of the packet that is hashed includes one or more packet header fields, and wherein the cardinality estimate is an estimated count of unique instances of the one or more packet header fields in the stream of packets.

4. The method of claim 1 wherein the first set of bits comprise the least significant bits of the hash value and wherein the second set of bits comprise the most significant bits of the hash value.

5. The method of claim 1 wherein the hash value is a binary value that is h bits long, wherein the first set of bits is b bits long, and wherein the TCAM includes h−b+1 entries.

6. The method of claim 1 wherein each entry in the TCAM comprises a data field holding a bitstring against which the second set of bits is matched and a result field holding a rarity index that indicates a rarity of the bitstring.

7. The method of claim 1 wherein the bucket array is maintained in a memory of the packet processor.

8. The method of claim 1 wherein the receiving, the hashing, the determining, the performing, the computing, and the writing are repeated over a time interval.

9. The method of claim 8 further comprising, upon expiration of the time interval:
computing, by software running on a central processing unit (CPU) of the network device, the cardinality estimate based on current values in the bucket array; and
clearing the current values in the bucket array.

10. The method of claim 1 wherein the cardinality estimate pertains to packets in the stream of packets that exhibit a packet classification characteristic, and wherein determining the address of the bucket comprises:
determining an identifier associated with the packet classification characteristic; and
determining the address based on the first set of bits and the identifier.

11. The method of claim 10 wherein the packet classification characteristic is an ingress port on which the packets are received, an egress port on which the packets are sent out, or a counting policy comprising one or more rules that the packets conform to.

12. A network device comprising:
a central processing unit (CPU);
a ternary content-addressable memory (TCAM); and
a packet processor,
wherein the packet processor is configured to produce a cardinality estimate for a stream of packets processed by the network device by:
receiving a packet that is part of the stream of packets;
hashing a portion of the packet using a hash function, the hashing resulting in a hash value;
determining an address of a bucket in a bucket array based on a first set of bits of the hash value;
performing a lookup into the TCAM using a second set of bits of the hash value, the lookup resulting in identification of a matched TCAM entry;
computing a maximum of a current value in the bucket and an index taken from the matched TCAM entry; and
writing the computed maximum into the bucket.

13. The network device of claim 12 wherein the portion of the packet that is hashed includes one or more packet header fields that identify a network flow to which the packet belongs, and wherein the cardinality estimate is an estimated count of unique network flows in the stream of packets.

14. The network device of claim 12 wherein the portion of the packet that is hashed includes one or more packet header fields, and wherein the cardinality estimate is an estimated count of unique instances of the one or more packet header fields in the stream of packets.

15. The network device of claim 12 wherein the bucket array is maintained in a memory of the packet processor.

16. The network device of claim 12 wherein the receiving, the hashing, the determining, the performing, the computing, and the writing are performed using one or more hardware counter engines of the packet processor.

17. The network device of claim 12 wherein the receiving, the hashing, the determining, the performing, the computing, and the writing are repeated over a time interval.

18. The network device of claim 17 wherein, upon expiration of the time interval, a software module running on the CPU computes the cardinality estimate based on current values in the bucket array and clears the current values.

19. The network device of claim 12 wherein the cardinality estimate pertains to packets in the stream of packets that exhibit a packet classification characteristic, and wherein determining the address of the bucket comprises:
determining an identifier associated with the packet classification characteristic; and
determining the address based on the first set of bits and the identifier.

20. A processor comprising hardware for producing a cardinality estimate for a stream of packets processed by the processor, the hardware being configured to:
receive a packet that is part of the stream of packets;
hash a portion of the packet using a hash function, resulting in a hash value;
determine an address of a bucket in a bucket array based on a first set of bits of the hash value;
perform a lookup into a ternary content-addressable memory (TCAM) using a second set of bits of the hash value, the lookup resulting in identification of a matched TCAM entry;
compute a maximum of a current value in the bucket and an index taken from the matched TCAM entry; and
write the computed maximum into the bucket.
